(19) United States
(12) Patent Application Publication
(10) Pub. No.: US 2023/0364987 A1
(43) Pub. Date: Nov. 16, 2023

(54) AUTOMOTIVE FUEL SYSTEM HAVING ELASTOMERIC SEALS INCORPORATING GRAPHENE

(71) Applicant: Martinrea International US Inc., Auburn Hills, MI (US)

(72) Inventors: Cory Doble, Ortonville, MI (US); Murali Chandrasekhar, Rochester, MI (US); Ryan Majewski, Grand Blanc, MI (US); Sorin Stancu, Dearborn, MI (US)

(73) Assignee: Martinrea International US Inc., Auburn Hills, MI (US)

(21) Appl. No.: 18/195,055

(22) Filed: May 9, 2023

Related U.S. Application Data
(60) Provisional application No. 63/340,062, filed on May 10, 2022.

(51) Int. Cl. B60K 15/04

(52) U.S. Cl. CPC B60K 15/04; B60K 2015/03269

(57) ABSTRACT

A capless fuel unit having an elongated tubular and cylindrical housing open at each end, the housing defining a first and a second longitudinally spaced fluid ports. A first flapper valve is associated with the first fluid port and a second flapper valve with the second fluid port, the flapper valves being movable between open and closed positions and resiliently urged toward their respective closed positions. A pressure relief valve is at least partially contained within an interior of the flapper valves. An arrangement of elastomeric seals incorporating a Graphene-derivative are positioned within the housing in proximity with the flapper valves for resisting hydrocarbon emission from fuel vapors escaping from the unit to the atmosphere.

### CROSS REFERENCE TO RELATED APPLICATIONS

The present application claims the priority of U.S. Ser. No. 63/340,062 filed May 10, 2022.

### FIELD OF THE INVENTION

The present invention relates generally to fuel systems exposed to the effects of permeation of hydrocarbons. More specifically, the present invention teaches an elastomeric seal incorporating Graphene, which incorporated into any of a vehicle fuel delivery, storage or recovery system.

### BACKGROUND OF THE INVENTION

Automotive fuel seals are known in the relevant art, which can be used to help reduce the permeation of hydrocarbons from different grades of gasoline within a vehicles fuel system. Stringent government regulations related to increasing awareness of climate issues have led to demands of enhanced control of automotive fuel emissions. In the late 1990s, automotive suppliers in the United States were forced to start implementing ORVR (Onboard Refueling Vapor Recovery) systems to meet EPA requirements for reducing automotive hydrocarbon emissions. Using low permeation elastomeric seals and materials is a key component to keep emissions down with ORVR systems.

One of the most common elastomeric material used in a vehicles fuel system to help reduce fuel permeation is FKM. This material is found in fuel pump thread ring seals, quick connector O-rings, Fill Limit Vent Valve/Combo Valve Seals, Inlet Check Valve seals, and Fuel Cap or Capless Seals. All of these components contribute and add up to the overall amount of a vehicle's hydrocarbon emissions, which is limited by government regulations. By adding Graphene into FKM or other elastomers such as FVMQ or NBR, the amount of hydrocarbons permeating through that material is reduced. FVMQ and NBR are not normally used to reduce permeation but are often used as secondary seals to help with other properties such as low temperature sealing. When Graphene is applied to the secondary seals along with the primary seals, this would only help improve the overall permeation of that sub-assembly.

More specifically for the seals being used in a Capless refueling system, there are usually one or two door seals along with one or two body or pipe seals. Additionally, there could be some sort of pressure relief seal that is designed to allow fuel vapor pressure to escape a fuel tank in severe conditions. Such seals are generally constructed out of FKM to reduce the amount of vapor emissions that are located inside of the fuel filler pipe after refueling or even under normal vehicle operating conditions. As will be described in reference to the present invention, adding Graphene to these seals would reduce the amount of fuel vapor emissions that are exiting the upper portion of the fuel filler pipe.

Graphene is a two-dimensional planar nanomaterial comprising of sp2 bonded carbon atoms packed in the honeycomb lattice. Many of the material properties, such as high tensile strength, high thermal and electrical conductivity, chemical and permeation resistance that makes Graphene lucrative stems from the unique bonding structure of the planar Graphene. However, the application of Graphene at a macroscopic scale for applications as in the automotive industry continues to be a challenge.

### SUMMARY OF THE INVENTION

The present invention describes use of Graphene-derivative elastomer composite system to provide premium quality automotive industry fuel system seals with improved mechanical and barrier properties. In particular, this includes the use of one or more elastomer seals incorporating Graphene-derivative such as can be integrated into a capless unit associated with a fuel filler tube.

In a non-limiting application, a capless fuel filling system includes an elongated tubular and cylindrical housing open at each end. Typically, the cylindrical housing is constructed from a plastic material for inexpensive yet durable construction.

First and second axially spaced fluid ports are formed within the housing, with the first fluid port positioned adjacent the inlet of the housing and the second fluid port positioned adjacent the outlet for the housing. The fluid ports are substantially axially aligned with each other and are dimensioned to receive a standard fuel filling nozzle (not shown) therethrough. The design of the fluid ports in the capless unit is further such that insertion of an unauthorized hose (such as for siphoning theft of the gas held in the tank) is prevented.

Flapper valves are associated with each of the fluid ports and are movable between open and a closed position. A spring urges each of the valves towards the closed position. Both flapper valves move away from the housing inlet and towards the housing outlet when moving from a closed to an open position, such as in response to insertion of the fuel filler pipe or nozzle. In this fashion, the fuel filling nozzle inserted into the inlet end of the housing passes through both the first and second fluid ports and, in doing so, pivots the first and second flapper valves from an open and to a closed position.

As further depicted, the capless unit includes an arrangement of seals incorporating a Graphene-derivative, including pairs of each of outer annular body seals, along with inner annular door seals and pressure relief seals associated each of the first and second fluid ports.

Other envisioned applications of the present invention include the Graphene-derivative materials being incorporated into the elastomer seals associated with a quick connector device for a fuel system, such including a male connector defining a first body and a female connector defining a second body to which said male connector is engaged to define a fluid communicating passageway. The arrangement of seals incorporated within at least one of the quick connector bodies resists hydrocarbon emission from fuel vapors escaping from the unit to the atmosphere.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a vehicle capless unit incorporating an arrangement of elastomeric seals incorporating a Graphene-derivative material according to one non-limiting embodiment of the present invention;

FIG. 2 is a plan cutaway of the vehicle capless unit shown in FIG. 1 and depicting an internal arrangement of body seals, pressure relief seals and door seals;

FIG. 3 is a further cutaway view similar to FIG. 2 and additionally depicting an arrangement of elastomeric seals for resisting hydrocarbon vapor emissions from exiting to the atmosphere;

FIG. 4 is an elevation view of a fluid quick connecter device according to a further embodiment of the present invention incorporating Graphene-derivative into the elastomer seals;

FIG. 5 is a cutaway view of the fluid connector device illustrating the tube with annular extending protuberance in an intermediate engaged position with a retainer latch; and

FIG. 6 is a further succeeding plan cutaway view of the fluid connector device of FIGS. 4-5 and illustrating the tube installed through the latch and with the sides of a separate verifier held open by alignment with the annular bead representing the tube in an installed position.

### DETAILED DESCRIPTION OF THE PREFERRED EMBODIMENTS

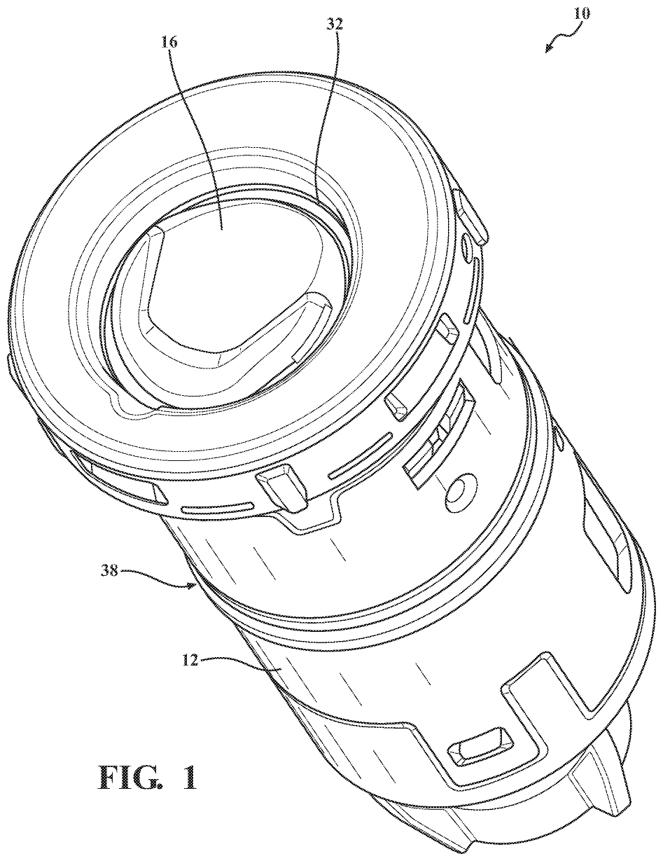

With reference to the attached illustrations, the present invention discloses a capless fuel unit or assembly, such as which incorporates an arrangement of elastomeric seals integrating Graphene-derivative. Specifically, FIG. 1 provides a perspective view of a vehicle capless unit, generally at 10, incorporating an arrangement of elastomeric seals incorporating Graphene-derivative according to one non-limiting embodiment of the present invention.

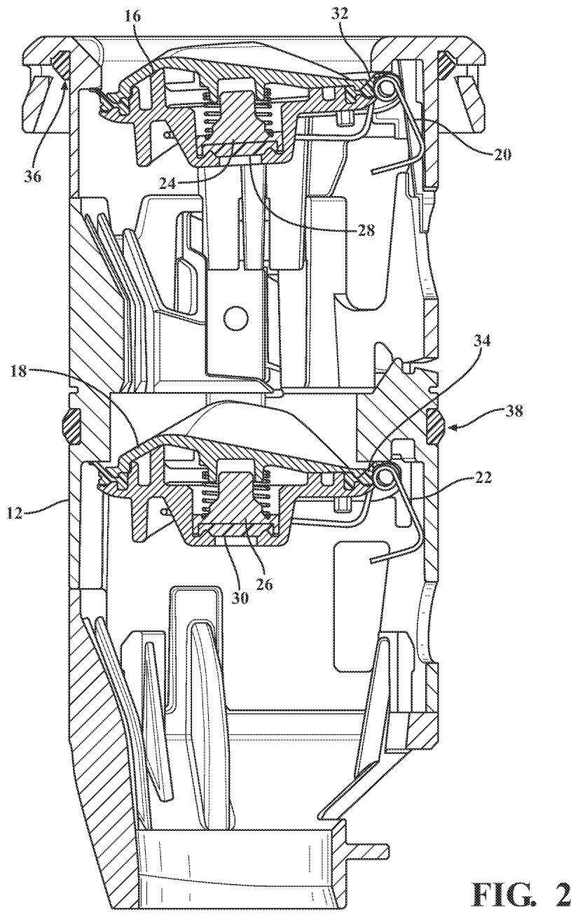

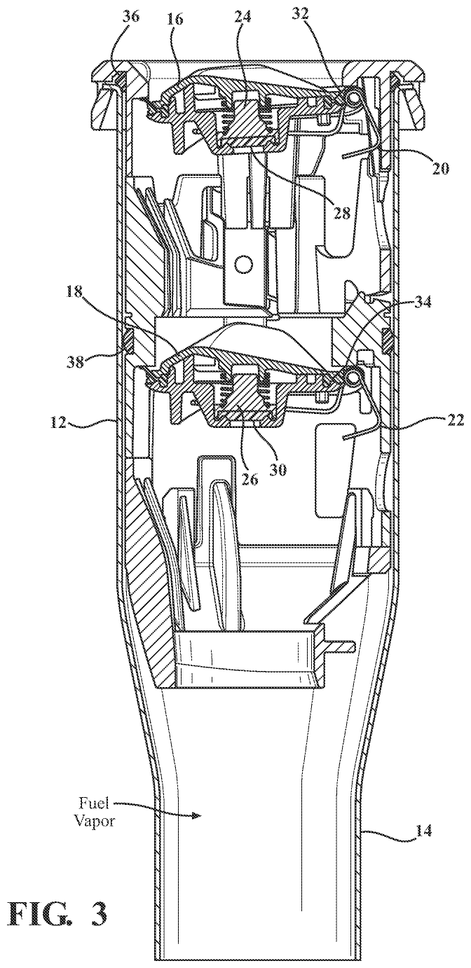

FIG. 2 further provides is a plan cutaway of the vehicle capless unit shown in FIG. 1 and depicts an internal arrangement of body seals, pressure relief seals and door seals, with successive FIG. 3 depicting a further cutaway view similar to FIG. 2 and additionally depicting an arrangement of elastomeric seals for resisting hydrocarbon vapor emissions from existing to the atmosphere.

With reference again to illustrations viewed collectively, an elongated tubular and cylindrical housing 12, such as having a plastic or polymer construction not limited to nylon, is shown which is open at each end. The housing 12 is, in the illustrated embodiment, incorporated into a fuel filler tube 14 (see FIG. 3) such that it is exposed to the presence of hydrocarbon fuel vapors emanating from the connected fuel tank (not shown).

As further shown, the housing defines first and second longitudinally spaced fluid ports, which correspond with the location of each of first 16 and second 18 flapper valves, these being movable between open and closed positions. In one non-limiting configuration, each of the first and second flapper valves further include first and second valve parts secured together by a snap fitting. Also depicted are a pair of springs 20 and 22 which resiliently urge the flapper valves 16/18 toward their respective closed positions.

Also depicted in each of FIGS. 2-3 are first 24 and second 26 pressure relief valves corresponding to the first 16 and second 18 flapper valves. As shown, the pressure relief valves are shown contained within an interior of the flapper valves.

The present invention further depicts an arrangement of elastomeric seals incorporating Graphene-derivative materials positioned within the housing in proximity with the flapper valves for resisting hydrocarbon emission from fuel vapors escaping from the unit to the atmosphere. As depicted, these include each of the first 28 and second 30 pressure relief seals located at the pressure relief valves 24/26.

Also included are first 32 and second 34 elastomeric door seals corresponding in placement along with the first 16 and second 18 flapper valves. Additional body seals 36 and 38 are configured into first and second axial spaced locations of the cylindrical housing. The arrangement of the elastomeric seals incorporating a Graphene-derivative operates to resist hydrocarbon vapor emissions from existing to the atmosphere.

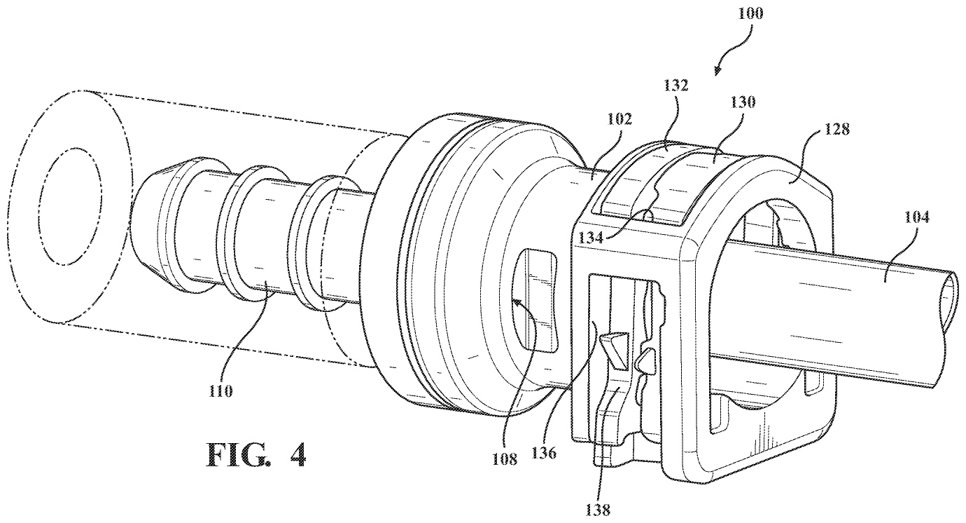

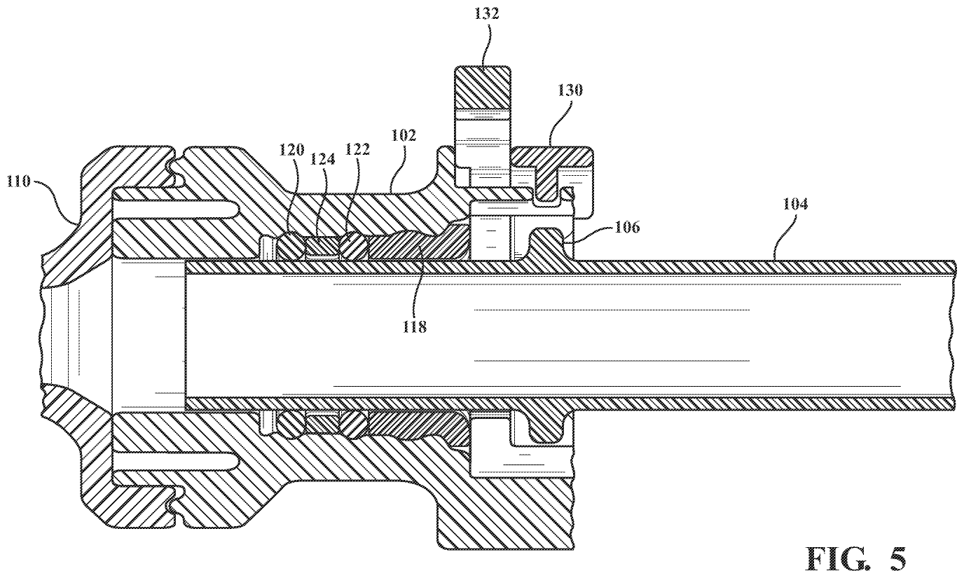

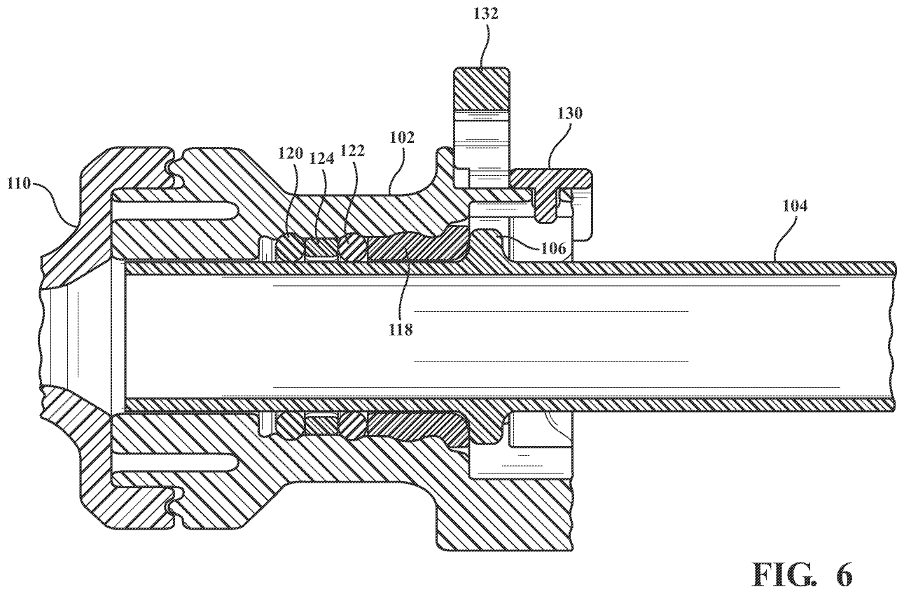

Referring to FIG. 4, an elevation view is shown at 100 of the fluid coupling according to a further embodiment of the present invention and in which some or all of the elastomeric seal components incorporate a Graphene-derivative material. The coupling has a housing 102 with a female part and an interconnected insertion tube 104. The tube 104 also includes a radially outwardly extending bead 106 (see subsequent FIGS. 5-6) adjacent its end which extends around the circumference of the cylindrical tube 104.

The housing female part 102 incorporates a throughbore 108 which communicates the female part with a connected male part 110, the throughbore receiving the tube 104 having the annular extending bead 106. Without limitation, the female part 102 and male part 110 of the quick connect housing can be constructed of any suitable material typically including a plastic, and it is further envisioned that a further hose or conduit (not shown) is secured over the narrowed diameter male part 110 so that the throughbore communicates the installed tube 104 with the outlet of the male part 110.

A heat staking operation is employed for securing a tubular outer spacer 118 within the housing female part in proximity to the receiving end of the tube 104 and annular bead 106. The spacer 118 is provided in combination with an arrangement of seals 120 and 122 and interposed annular support 124 compressed between the outer spacer 118 and an inward annular shoulder location 126 for providing pressurized sealing support between the female 102 and male 110 portions of the housing. As previously described, the material construction of the seals 120/122 can incorporate Graphene derivative material for resisting hydrocarbon emission from fuel vapors to the atmosphere.

Without limitation, the heat staking operation can be provided according to any plurality and angular offset, such as including but not limited to placing the heat stake locations at 60 degree offset (total of six), as well as providing any other shape or profile. In any application, the heat staking operation ensures that the outer spacer is retained within the body head and avoids instances of axial separation, such as following detached separation of the tube and bead in the manner subsequently described.

The female housing part 102 further integrates an insertion end 128 (this being shown in cutaway in the remaining views) having an outline corresponding to each of a latch 130 and verifier 132. The latch and verifier are provided in a stacked arrangement and installed within the female part 102 in communication with the inserting direction of the tube 104 through the interior throughbore 108, these further being arranged in a stacked arrangement and supported within the end 128 through a top located installation slot (see inner extending edge profile 134). The insertion end 128 further exhibits opposite side cutout profiles, one of which is illustrated by perimeter edge 136 in FIG. 1 for seating extending pairs of extending sides or legs of each of the latch 130 and verifier 132, and such that the latch and verifier each exhibit a generally “U” shape surrounding on three sides the cross sectional profile of the inserted tube 14.

Without limitation as to any of the distinct embodiments previously described in each of FIGS. 1-3 and 4-6, the group of Graphene-derivatives may again include, but are not limited to, any of a Graphene, monolayer Graphene, few layered Graphene, Graphene oxide, reduced Graphene oxide, and functionalized Graphene. The loading concentration of Graphene-derivatives may vary from 0.1-60 percentage by weight. The seal material may include, but not restricted to any of a fluorinated carbon based synthetic rubber (FKM), fluorosilicane or silicone rubber (FVMQ), thermoplastic vulcanizates (TPV), ethylene propylene diene monomer (EPDM), hydrogenated nitrile butadiene rubber (HNBR), or nitrile butadiene rubber (NBR).

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A capless fuel unit comprising:
an elongated tubular and cylindrical housing open at each end, said housing defining a first and a second longitudinally spaced fluid ports,
a first flapper valve associated with said first fluid port and a second flapper valve associated with said second fluid port, said flapper valves being movable between an open and a closed position and resiliently urged toward their respective closed positions,
a pressure relief valve contained within an interior of each of said flapper valves; and
an arrangement of elastomeric seals incorporating a Graphene-derivative positioned within said housing in proximity with said flapper valves for resisting hydrocarbon emission from fuel vapors escaping from the unit to the atmosphere.

2. The apparatus as defined in claim 1, said elastomeric seals further comprising first and second pressure relief seals

3. The apparatus as defined in claim 1 and further comprising first and second springs urging said first and second flapper valves towards a closed position.

4. The apparatus as defined in claim 1, said elastomeric seals further comprising door seals surrounding said flapper valves.

5. The apparatus as defined in claim 1, said elastomeric seals further comprising body seals configured into first and second axial spaced locations of said cylindrical housing.

6. The apparatus as defined in claim 1, each of said first and second flapper valves further comprising first and second valve parts secured together by a snap fitting.

7. The apparatus as defined in claim 1, said Graphene-derivative further comprising at least one selected from a group including monolayer Graphene, few layered Graphene, Graphene oxide, reduced Graphene oxide, and functionalized Graphene.

8. The apparatus as defined in claim 1, said elastomer seals further comprising any of a fluorinated carbon based synthetic rubber, fluorosilicane rubber, thermoplastic vulcanizates, ethylene propylene diene monomer, hydrogenated nitrile butadiene rubber, or nitrile butadiene rubber.

9. A quick connector device for a fuel system, comprising:
a male connector defining a first body and a female connector defining a second body to which said male connector is engaged to define a fluid communicating passageway;
an arrangement of elastomeric seals incorporating within at least one of said bodies, at least one of the elastomeric seals incorporating Graphene for the resistance of hydrocarbon emission from fuel vapors escaping from the unit to the atmosphere.

10. The quick connector of claim 9, said Graphene further comprising a Graphene-derivative including at least one selected from a group including monolayer Graphene, few layered Graphene, Graphene oxide, reduced Graphene oxide, and functionalized Graphene.

11. The quick connector of claim 9, said elastomer seals further comprising any of a fluorinated carbon based synthetic rubber), fluorosilicane rubber, thermoplastic vulcanizates, ethylene propylene diene monomer, hydrogenated nitrile butadiene rubber, or nitrile butadiene rubber.
